(19) United States
(12) Patent Application Publication
(10) Pub. No.: US 2026/0369118 A1
(43) Pub. Date: Nov. 19, 2026

(54) SPLIT ARCHITECTURE MODULE POSITION SENSOR

(71) Applicant: Cardtronics USA, Inc., Atlanta, GA (US)

(72) Inventors: Ryan Plomer, Arbroath (GB); Mark Robert Forsyth Smith, Perthshire (GB)

(21) Appl. No.: 19/207,638

(22) Filed: May 14, 2025

(51) Int. Cl. G07F 7/04; G07F 19/00

(52) U.S. Cl. CPC G07F 7/04; G07F 19/20

(57) ABSTRACT

A system and technique may be used with a scalable recycler of an automated teller machine (ATM) including a safe. An example scalable recycler may include a moveable component including a positioning magnet, the moveable component slidably coupled to a servicing track, and an intermediate transport component affixed to the servicing track, the intermediate transport component configured to convey media within the ATM. The example scalable recycler may include a hall effect sensor coupled to the servicing track, the hall effect sensor configured to output sensor data corresponding to a position of the moveable component based on proximity of the hall effect sensor to the positioning magnet.

### BACKGROUND

An Automated Teller Machine (ATM) is an electronic banking device that allows customers to perform financial transactions, such as withdrawing cash, checking account balances, and making deposits, without the need for a human bank teller. ATMs are typically connected to financial networks and are commonly located at bank branches, shopping centers, and other convenient public locations to provide easy access to banking services. ATMs usually require a constant power supply to function properly and securely.

### SUMMARY

In various examples, methods and systems for use with a scalable recycler of an automated teller machine (ATM) including a safe are presented.

According to an example, a scalable recycler may include a moveable component including a positioning magnet, the moveable component slidably coupled to a servicing track, and an intermediate transport component affixed to the servicing track, the intermediate transport component configured to convey media within the ATM. The scalable recycler may include a hall effect sensor coupled to the servicing track, the hall effect sensor configured to output sensor data corresponding to a position of the moveable component based on proximity of the hall effect sensor to the positioning magnet.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various examples discussed in the present document.

FIG. 1 illustrates a scalable recycler in accordance with some examples.

FIG. 2 illustrates a hall effect sensor and magnet system in accordance with some examples.

FIG. 3 illustrates a portion of a scalable recycler with a hall effect sensor and magnet system installed in accordance with some examples.

FIG. 4 illustrates generally a flowchart showing a technique for monitoring alignment positioning of components in a scalable recycler of an automated teller machine (ATM) having a safe in accordance with some examples.

FIG. 5 illustrates generally an example of a block diagram of a machine upon which any one or more of the techniques discussed herein may perform in accordance with some examples.

### DETAILED DESCRIPTION

The systems and techniques described herein provide reliable alignment information for two moveable components of a scalable recycler. The scalable recycler may include a moveable component with a servicing track. The first moveable component may include a hall effect sensor coupled to the servicing track. The scalable recycler may include a magnet. The hall effect sensor may output sensor data used to identify a position of the moveable component based on a location of the magnet. The scalable recycler may include may include a safe inside an ATM. The scalable recycler may include a second hall effect sensor configured to output sensor data corresponding to a location of a second magnet coupled to a second moveable component. The second hall effect sensor may be coupled to a second servicing track.

A hall effect sensor measures a voltage difference across an electrical conductor exposed to a magnetic field. A hall effect sensor includes a semiconductor plate (typically silicon) with current flowing through it. When the plate is subject to a magnetic field oriented perpendicular to the current flow, the Lorentz force pushes charge carriers (e.g., electrons) toward one edge of the semiconductor, generating a voltage difference across its width. This voltage directly correlates with the magnetic field strength. A hall effect sensor includes integrated circuitry that may amplify or convert this voltage into sensor data that may be output (e.g., to a computing device, such as processing circuitry of an ATM). The output may be identify field intensity, and be compared to a known or identified alignment field intensity. When the identified field intensity matches the alignment field intensity, the hall effect sensor may be considered properly aligned with a magnet. When the identified field intensity does not match the alignment field intensity, the hall effect sensor may be identified as not properly aligned. Output from the hall effect sensor may be continuous or discrete, such as in real-time or near real-time. During diagnostic work on an ATM, a moveable component may be moved into alignment based on instructions to move the hall effect sensor based on a currently identified field intensity and the alignment field intensity.

Component positioning within a scalable recycler is important to functioning of the scalable recycler. In example scalable recyclers with a split architecture, there are two critical paths that must be accurately aligned in a home position for operation. The two critical paths are defined by two components, each of which is moveable via being racked out for replenishment or servicing. An upper component must be aligned to an intermediate transport (IMT), and a lower component must be aligned to the IMT. Without these two critical paths, the scalable recycler may not function. Currently, it is difficult or impossible to identify positions of the two components, requiring manual measurement that in some circumstances is not possible due to arrangement of components in the scalable recycler. Manual measurement is not accurate enough to properly gauge alignment and requires custom tooling, which may not be available.

The systems and techniques described herein use a hall effect sensor (e.g., a 3D linear hall effect sensor) to identify a position of an upper or lower component of a scalable recycler. The hall effect sensor may be used positionally in the X, Y, or Z axes to output precise sensor data about a position of the upper or lower component within the scalable recycler. In some examples, the sensor data may be fed back to a diagnostic tool within the ATM for use by a diagnostic engineer, a customer engineer, or for improving manufacturing.

The scalable recycler is operable with margins for correct positioning of upper and lower components in the millimeters. The scalable recycler relies on consistent positioning of the lower and upper components with regard to a fixed intermediate transport to transport media from outside of a safe of the scalable recycler from a customer to inside the safe. During the life of a scalable recycler, the scalable recycler may be subject to wear and tear, which may the replacement of parts over time. Wear in the latch or slides may correlate to movement of a component over time, with the component eventually becoming out of alignment. When a component is out of alignment, a failure at the intermediate transport occurs due to mispositioning. When a component is inaccurately positioned, this issue may remain unresolved or misdiagnosed for the lifetime of the scalable recycler, causing unnecessary service calls or wasted service parts.

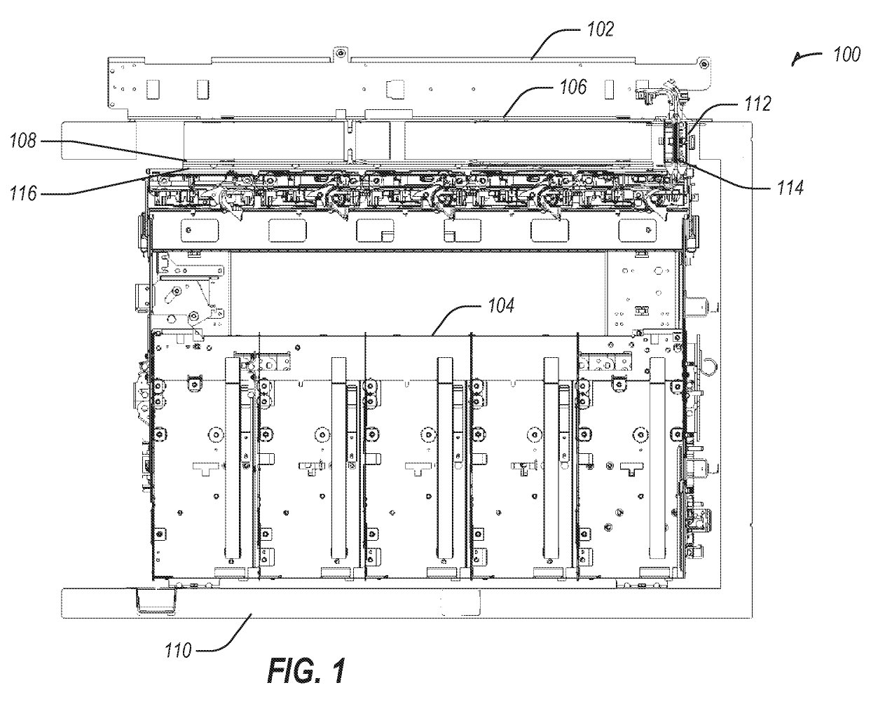

FIG. 1 illustrates a scalable recycler 100 in accordance with some examples. The scalable recycler 100 includes a first moveable component 102, a secure safe 110 including a lower module 104, the lower module 104 including a second moveable component 108, and an intermediate transport 112. The first moveable component 102 includes a first servicing track 106. The second moveable component 108 is configured to move along a second servicing track 116. The first moveable component 102 and the second moveable component 108 are configured to move out of the secure safe 110 to the left in the diagram shown in FIG. 1.

When aligned, the first moveable component 102 and the second moveable component 108 form a critical transport path 114 within the intermediate transport 112. The critical transport path 114 has a tolerance of a few millimeters (e.g., plus or minus one millimeter, two millimeters, three millimeters, etc.), meaning that a misalignment of the first moveable component 102 or the second moveable component 108 may cause the scalable recycler 100 to be unable to receive or output media.

The first moveable component 102 and the second moveable component 108 of the scalable recycler 100 are configured to traverse or slide out of the scalable recycler 100 (e.g., out of the safe 110 for the second moveable component 108) for replenishment or servicing. The intermediate transport is fixed and stays in place when the first moveable component 102 or the second moveable component 108 are moved. The first moveable component 102 and the second moveable component 108 are mounted to retracts (e.g., the first servicing track 106 or the second servicing track 116), and the retracts are mounted to a top (e.g., for the first servicing track 106) and an underside (e.g., for the second servicing track 116) of the secure safe 110. The intermediate transport 112 is fixed to the first servicing track 106 and the second servicing track 116 to bridge the gap between the first moveable component 102 and the second moveable component 108 through a wall of the secure safe 110. In some examples, the second moveable component 108 has a mass of at least 60kg and is moveable within the second servicing track 116 up to one meter (e.g., out of the secure safe 110).

The first servicing track 106 and the second servicing track 116 are fixed with respect to the secure safe 110 (e.g., not configured to be moveable). Since the first servicing track 106 and the second servicing track 116 are fixed, a first linear hall effect sensor may be affixed to the first servicing track 106 and a second linear hall effect sensor may be affixed to the second servicing track 116. The hall effect sensors may be positioned to obtain precise readings of a position of the first moveable component 102 and the second moveable component 108, respectively. The first moveable component 102 may include a first positioning magnet. The second moveable component 108 may include a second positioning magnet. Further discussion related to the hall effect sensors and the magnets is described below.

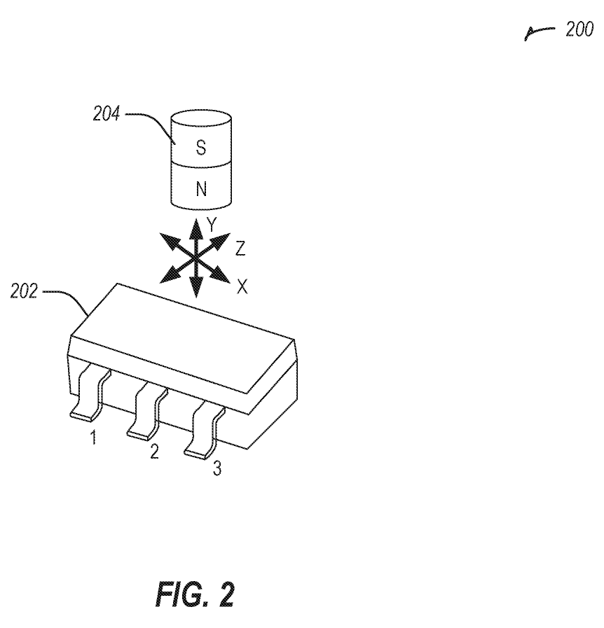

FIG. 2 illustrates a hall effect sensor and magnet system 200 in accordance with some examples. The hall effect sensor and magnet system 200 includes a hall effect sensor 202 and a magnet 204. The hall effect sensor 202 may be a 3D linear hall effect sensor. The 3D linear hall effect sensor may be a 3D device that integrates hall effect sensors in x, y, and z axes. When the magnet 204 is affixed to a moving portion of a scalable recycler, the hall effect sensor 202 may determine a location of the magnet in three dimensions (e.g., along each of the x, y, and z axes, for example, using a set of three hall effect sensors in the hall effect sensor 202). The hall effect sensor 202 may be mounted on moveable components of the scalable recycler. The hall effect sensor 202 may output sensor data (e.g., a voltage) corresponding to a location of the magnet 204. Processing circuitry (e.g., a computer, such as a computer of a scalable recycler, may be used to convert the sensor data to a location of the magnet 204, and in turn to a position or orientation of a moveable component of the scalable recycler. While the hall effect sensor 202 is described as a three dimensional hall effect sensor, fewer or another number of dimensions may be used.

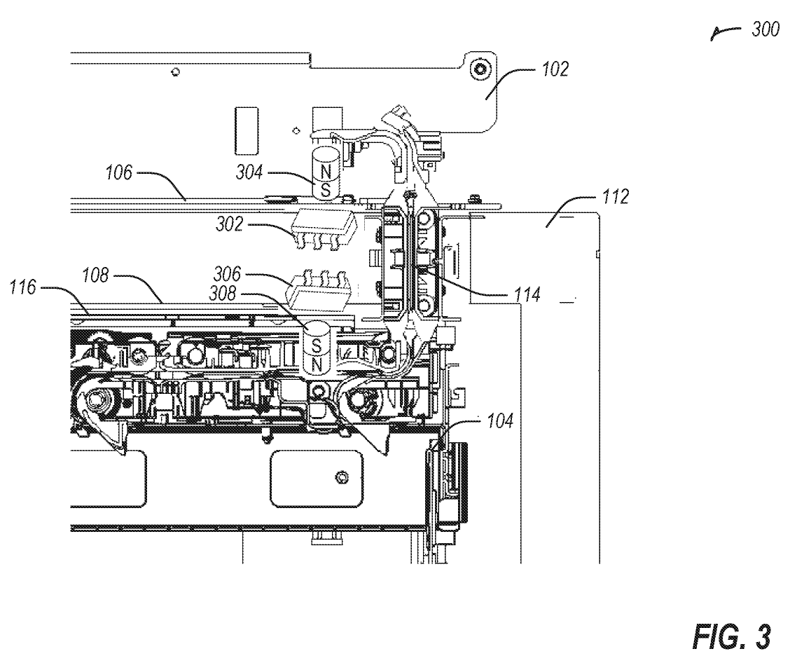

FIG. 3 illustrates a portion of a scalable recycler 300 (e.g., a portion of the scalable recycler 100) with a hall effect sensor and magnet system installed in accordance with some examples. The portion of the scalable recycler 300 illustrates portions of the first moveable component 102, the lower module 104, the first servicing track 106, the second moveable component 108, the intermediate transport 112, and the second servicing track 116. The critical transport path 114 is also shown in FIG. 3 in more detail.

A first hall effect sensor 302 is attached, affixed, or otherwise coupled to the first servicing track 106, and a first magnet 304 is attached, affixed, or otherwise coupled to the first moveable component 102. A second hall effect sensor 306 is attached, affixed, or otherwise coupled to the second servicing track 116, and a second magnet 308 is attached, affixed, or otherwise coupled to the second moveable component 108.

In some examples, the magnet 304 is mounted to the first moveable component 102 at a transport entry point that is nominally central. The hall effect sensor 302 may read a magnetic field strength of the magnet 304 and convert the magnetic field strength into a voltage or a distance (e.g., into an output voltage that may be converted to the distance by processing circuitry). The hall effect sensors 302 or 306 may output sensor data over time, which may be used to determine where the first moveable component 102 or the second moveable component 108 move over time, for example as the first moveable component 102 or the second moveable component 108 experience wear and tear or damage. Time-based data may be used to fault find by engineering or field services. In some examples, sensor data may be displayed within an ATM diagnostic tool (e.g., at an ATM housing the scalable recycler 100, on a handheld device, or the like). By having this sensor data viewable by a diagnostician, an engineer, etc., the prior need for specific custom measurement tooling and knowledge of how to take these measurements is not required. A user interface (e.g., of the ATM, on a handheld device such as a tablet or phone, or the like) may be used to instruct a user how to fix a misalignment based on sensor data from the hall effect sensor 302 or the hall effect sensor 306.

In some examples, the hall effect sensors 302 and 306 may be used to ensure the first moveable component 102 and the second moveable component 108 are positioned correctly during assembly, such as by a manufacturer to reduce out of box failures.

In some examples, a latch of the scalable recycler 100 may become damaged over time. For example, the second moveable component 108 may come into contact with the latch and deform the latch by applying a force to the latch. When the latch becomes damaged or deformed, the latch may prevent or cause misalignment of the second moveable component 108. For example, the latch may become deformed such that when the second moveable component 108 is returned from service or replenishment, the second moveable component 108 is insertable past an optimal alignment (e.g., further into the secure safe 110). In some examples, the intermediate transport 112 may become damaged or misaligned due to heavy racking (e.g., returning the second moveable component 108 forcibly to the secure safe 110). In these examples, where another component of the scalable recycler 100 is damaged, identification of a misalignment of the first moveable component 102 or the second moveable component 108 may provide an indication of the other damage. For example, a servicing engineer may be prepared to fix or replace a damaged component when sent to service the scalable recycler 100, reducing a need for repeated service trips due to lack of proper equipment.

In some examples, sensor data from the hall effect sensor 302 or the hall effect sensor 306 may be sent (e.g., by processing circuitry of an ATM housing the scalable recycler 100) to a remote device, such as for remote diagnostics. Remote monitoring may prevent multiple service trips (e.g., a diagnostic visit and a service visit with correct equipment). In other examples, during a diagnostic visit, remote monitoring may be used to guide an engineer to address the misalignment issue, for example before leaving the visit. For example, a diagnostic engineer may complete diagnostics (e.g., for another issue), and close up the secure safe 110, believing that the scalable recycler 100 is fully operational, but not knowing that one or both of the first moveable component 102 or the second moveable component 108 is misaligned. A remote monitoring device may send an indication to the diagnostic engineer, the indication identifying the misalignment.

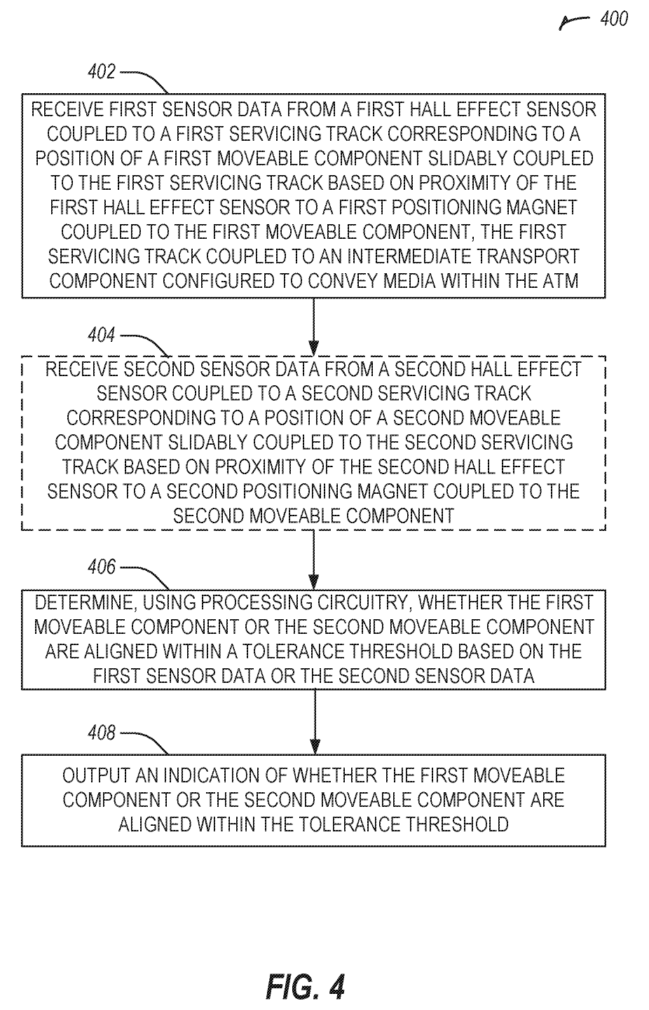

FIG. 4 illustrates generally a flowchart showing a technique 400 for monitoring alignment positioning of components in a scalable recycler of an automated teller machine (ATM) having a safe in accordance with some examples.

The technique 400 includes an operation 402 to receive first sensor data from a first hall effect sensor coupled to a first servicing track corresponding to a position of a first moveable component slidably coupled to the first servicing track based on proximity of the first hall effect sensor to a first positioning magnet coupled to the first moveable component, the first servicing track coupled to an intermediate transport component configured to convey media within the ATM.

The technique 400 includes an optional operation 404 to receive second sensor data from a second hall effect sensor coupled to a second servicing track corresponding to a position of a second moveable component slidably coupled to the second servicing track based on proximity of the second hall effect sensor to a second positioning magnet coupled to the second moveable component.

The technique 400 includes an operation 406 to determine, using processing circuitry, whether the first moveable component or the second moveable component are aligned within a tolerance threshold based on the first sensor data or the second sensor data. The tolerance threshold may be 2 millimeters along any axis in three-dimensions. The processing circuitry may be remote from the ATM. The processing circuitry may be within the ATM.

The technique 400 includes an operation 408 to output an indication of whether the first moveable component or the second moveable component are aligned within the tolerance threshold. Operation 408 may include outputting the indication during a diagnostic test of the ATM. Operation 408 may include outputting a positional error and direction corresponding to the first moveable component or the second moveable component. Operation 408 may include outputting the indication on a user interface of the ATM. Operation 408 may include outputting a suggested fix to a misalignment of the first moveable component or the second moveable component. Outputting the suggested fix may include outputting a suggested change to a latch corresponding to the second moveable component. Outputting the suggested fix may include outputting an indication that the intermediate transport component is compromised.

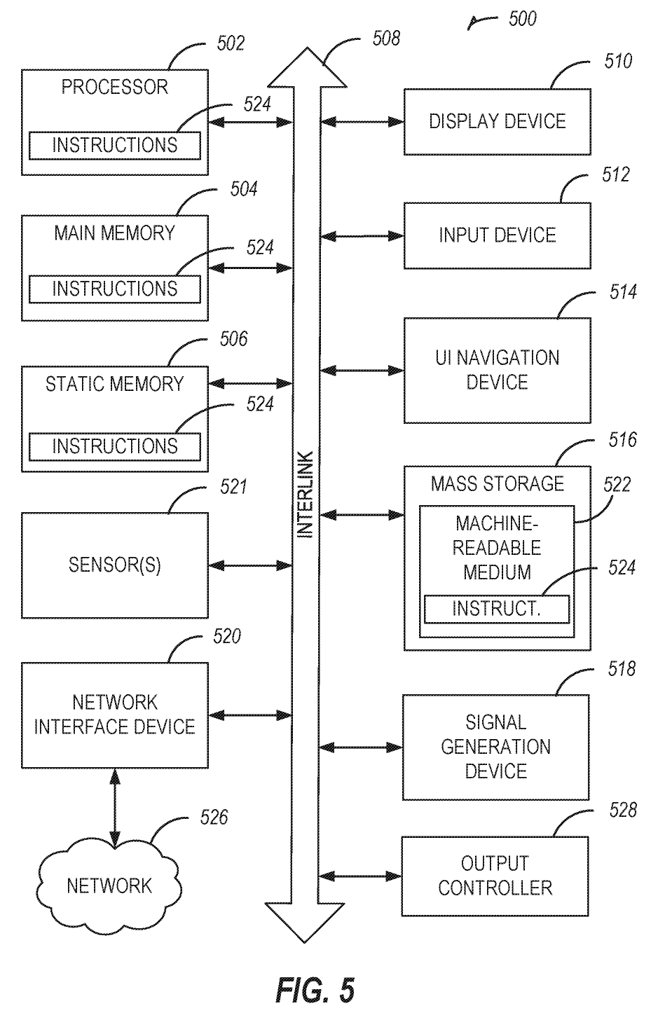

FIG. 5 illustrates generally an example of a block diagram of a machine 500 upon which any one or more of the techniques discussed herein may perform in accordance with some examples. In alternative examples, the machine 500 may operate as a standalone device or may be connected (e.g., networked) to other machines. In a networked deployment, the machine 500 may operate in the capacity of a server machine, a client machine, or both in server-client network environments. In an example, the machine 500 may act as a peer machine in peer-to-peer (P2P) (or other distributed) network environment. The machine 500 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the device is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 500 may include a hardware processor 502 (e.g., a central processing unit (CPU), a graphics processing unit (GPU), a hardware processor core, or any combination thereof), a main memory 504 and a static memory 506, some or all of which may communicate with each other via an interlink (e.g., bus) 508. The machine 500 may further include a display unit 510, an alphanumeric input device 512 (e.g., a keyboard), and a user interface (UI) navigation device 514 (e.g., a mouse). In an example, the display unit 510, alphanumeric input device 512 and UI navigation device 514 may be a touch screen display. The machine 500 may additionally include a storage device (e.g., drive unit) 516, a signal generation device 518 (e.g., a speaker), a network interface device 520, and one or more sensors 521, such as a global positioning system (GPS) sensor, compass, accelerometer, or other sensor. The machine 500 may include an output controller 528, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 516 may include a machine readable medium 522 that is non-transitory on which is stored one or more sets of data structures or instructions 524 (e.g., software) embodying or utilized by any one or more of the techniques or functions described herein. The instructions 524 may also reside, completely or at least partially, within the main memory 504, within static memory 506, or within the hardware processor 502 during execution thereof by the machine 500. In an example, one or any combination of the hardware processor 502, the main memory 504, the static memory 506, or the storage device 516 may constitute machine readable media.

While the machine readable medium 522 is illustrated as a single medium, the term "machine readable medium" may include a single medium or multiple media (e.g., a centralized or distributed database, and/or associated caches and servers) configured to store the one or more instructions 524.

The term “machine readable medium” may include any medium that is capable of storing, encoding, or carrying instructions for execution by the machine 500 and that cause the machine 500 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 524 may further be transmitted or received over a communications network 526 using a transmission medium via the network interface device 520 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), or wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, peer-to-peer (P2P) networks, among others. In an example, the network interface device 520 may include one or more physical jacks (e.g., Ethernet, coaxial, or phone jacks) or one or more antennas to connect to the communications network 526. In an example, the network interface device 520 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 500, and includes digital or analog communications signals or other intangible medium to facilitate communication of such software.

Each of these non-limiting examples may stand on its own, or may be combined in various permutations or combinations with one or more of the other examples.

Example 1 is a scalable recycler of an automated teller machine (ATM) including a safe, the scalable recycler comprising: a first moveable component including a first positioning magnet, the first moveable component slidably coupled to a first servicing track; a second moveable component including a second positioning magnet, the second moveable component slidably coupled to a second servicing track; an intermediate transport component affixed to the first servicing track, the intermediate transport component configured to convey media between the second moveable component within the safe and the first moveable component outside the safe; a first hall effect sensor coupled to the first servicing track, the first hall effect sensor configured to output first sensor data corresponding to a position of the first moveable component based on proximity of the first hall effect sensor to the first positioning magnet; and a second hall effect sensor coupled to a second servicing track, the second hall effect sensor configured to output second sensor data corresponding to a position of the second moveable component based on proximity of the second hall effect sensor to the second positioning magnet.

In Example 2, the subject matter of Example 1 includes, wherein the second moveable component includes a set of cassettes configured to hold media.

In Example 3, the subject matter of Examples 1–2 includes, wherein the first sensor data and the second sensor data include three-dimensional sensor data.

In Example 4, the subject matter of Examples 1–3 includes, wherein the second moveable component has a mass of at least 60kg and is moveable within a track up to one meter.

In Example 5, the subject matter of Examples 1–4 includes, wherein the safe further includes a latch, and wherein the position of the second moveable component is affected by an arrangement of the latch.

In Example 6, the subject matter of Examples 1–5 includes, wherein the first servicing track is affixed to an outer top of the safe.

In Example 7, the subject matter of Examples 1–6 includes, wherein the second servicing track is affixed to an internal wall of the safe.

Example 8 is a method for monitoring alignment positioning of components in a scalable recycler of an automated teller machine (ATM) having a safe, the method comprising: receiving first sensor data from a first hall effect sensor coupled to a first servicing track corresponding to a position of a first moveable component slidably coupled to the first servicing track based on proximity of the first hall effect sensor to a first positioning magnet coupled to the first moveable component, the first servicing track coupled to an intermediate transport component configured to convey media within the ATM; receiving second sensor data from a second hall effect sensor coupled to a second servicing track corresponding to a position of a second moveable component slidably coupled to the second servicing track based on proximity of the second hall effect sensor to a second positioning magnet coupled to the second moveable component; determining, using processing circuitry, whether the first moveable component and the second moveable component are aligned within a tolerance threshold based on the first sensor data and the second sensor data; and outputting an indication of whether the first moveable component and the second moveable component are aligned within the tolerance threshold.

In Example 9, the subject matter of Example 8 includes, wherein the tolerance threshold is 2 millimeters along any axis in three dimensions.

In Example 10, the subject matter of Examples 8–9 includes, wherein outputting the indication includes outputting the indication during a diagnostic test of the ATM.

In Example 11, the subject matter of Examples 8–10 includes, wherein outputting the indication includes outputting a positional error and direction corresponding to the first moveable component or the second moveable component.

In Example 12, the subject matter of Examples 8–11 includes, wherein outputting the indication includes outputting the indication on a user interface of the ATM.

In Example 13, the subject matter of Examples 8–12 includes, wherein outputting the indication includes outputting a suggested fix to a misalignment of the first moveable component or the second moveable component.

In Example 14, the subject matter of Example 13 includes, outputting the suggested fix includes outputting a suggested change to a latch corresponding to the second moveable component.

In Example 15, the subject matter of Examples 13–14 includes, outputting the suggested fix includes outputting an indication that the intermediate transport component is compromised.

In Example 16, the subject matter of Examples 8–15 includes, wherein the processing circuitry is remote from the ATM.

In Example 17, the subject matter of Examples 8–16 includes, wherein the processing circuitry is within the ATM.

Example 18 is a scalable recycler of an automated teller machine (ATM), the scalable recycler comprising: a moveable component including a positioning magnet, the moveable component slidably coupled to a servicing track; an intermediate transport component affixed to the servicing track, the intermediate transport component configured to convey media within the ATM; and a hall effect sensor coupled to the servicing track, the hall effect sensor configured to output sensor data corresponding to a position of the moveable component based on proximity of the hall effect sensor to the positioning magnet.

In Example 19, the subject matter of Example 18 includes, wherein the sensor data includes three-dimensional sensor data.

In Example 20, the subject matter of Examples 18–19 includes, wherein the servicing track is affixed to an outer top of a safe.

Example 21 is a scalable recycler of an automated teller machine (ATM), the scalable recycler comprising: a moveable component including a positioning magnet, the moveable component slidably coupled to a servicing track that is affixed to a safe; an intermediate transport component affixed to the safe, the intermediate transport component configured to convey media within the ATM; and a hall effect sensor coupled to the servicing track, the hall effect sensor configured to output sensor data corresponding to a position of the moveable component based on proximity of the hall effect sensor to the positioning magnet.

In Example 22, the subject matter of Example 21 includes, wherein the moveable component includes a set of cassettes configured to hold media.

In Example 23, the subject matter of Examples 21–22 includes, wherein the sensor data includes three-dimensional sensor data.

In Example 24, the subject matter of Examples 21–23 includes, kg and is moveable within a track up to one meter.

In Example 25, the subject matter of Examples 21–24 includes, wherein the safe further includes a latch, and wherein the position of the moveable component is affected by an arrangement of the latch.

In Example 26, the subject matter of Examples 21–25 includes, wherein the servicing track is affixed to an internal wall of the safe.

Example 27 is a method for monitoring alignment positioning of a component in a scalable recycler of an automated teller machine (ATM), the method comprising: receiving sensor data from a hall effect sensor coupled to a servicing track corresponding to a position of a moveable component slidably coupled to the servicing track based on proximity of the hall effect sensor to a positioning magnet coupled to the moveable component; determining, using processing circuitry, whether the moveable component is aligned within a tolerance threshold based on the sensor data; and outputting an indication of whether the moveable component is aligned within the tolerance threshold.

In Example 28, the subject matter of Example 27 includes, wherein the tolerance threshold is 2 millimeters along any axis in three-dimensions.

In Example 29, the subject matter of Examples 27–28 includes, wherein outputting the indication includes outputting the indication during a diagnostic test of the ATM.

In Example 30, the subject matter of Examples 27–29 includes, wherein outputting the indication includes outputting a positional error and direction corresponding to the moveable component.

In Example 31, the subject matter of Examples 27–30 includes, wherein outputting the indication includes outputting the indication on a user interface of the ATM.

In Example 32, the subject matter of Examples 27–31 includes, wherein outputting the indication includes outputting a suggested fix to a misalignment of the moveable component.

In Example 33, the subject matter of Example 32 includes, outputting the suggested fix includes outputting a suggested change to a latch corresponding to the moveable component.

In Example 34, the subject matter of Examples 32–33 includes, outputting the suggested fix includes outputting an indication that an intermediate transport component is compromised.

In Example 35, the subject matter of Examples 27–34 includes, wherein the processing circuitry is remote from the ATM.

In Example 36, the subject matter of Examples 27–35 includes, wherein the processing circuitry is within the ATM.

Example 37 is at least one machine-readable medium including instructions that, when executed by processing circuitry, cause the processing circuitry to perform operations to implement of any of Examples 1–36.

Example 38 is an apparatus comprising means to implement of any of Examples 1–36.

Example 39 is a system to implement of any of Examples 1–36.

Example 40 is a method to implement of any of Examples 1–36.

Method examples described herein may be machine or computer-implemented at least in part. Some examples may include a computer-readable medium or machine-readable medium encoded with instructions operable to configure an electronic device to perform methods as described in the above examples. An implementation of such methods may include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of these tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

What is claimed is:

1. A scalable recycler of an automated teller machine (ATM) including a safe, the scalable recycler comprising:
a first moveable component including a first positioning magnet, the first moveable component slidably coupled to a first servicing track;
a second moveable component including a second positioning magnet, the second moveable component slidably coupled to a second servicing track;
an intermediate transport component affixed to the first servicing track, the intermediate transport component configured to convey media between the second moveable component within the safe and the first moveable component outside the safe;
a first hall effect sensor coupled to the first servicing track, the first hall effect sensor configured to output first sensor data corresponding to a position of the first moveable component based on proximity of the first hall effect sensor to the first positioning magnet; and
a second hall effect sensor coupled to a second servicing track, the second hall effect sensor configured to output second sensor data corresponding to a position of the second moveable component based on proximity of the second hall effect sensor to the second positioning magnet.

2. The scalable recycler of claim 1, wherein the second moveable component includes a set of cassettes configured to hold media.

3. The scalable recycler of claim 1, wherein the first sensor data and the second sensor data include three-dimensional sensor data.

4. The scalable recycler of claim 1, wherein the second moveable component has a mass of at least 60kg and is moveable within a track up to one meter.

5. The scalable recycler of claim 1, wherein the safe further includes a latch, and wherein the position of the second moveable component is affected by an arrangement of the latch.

6. The scalable recycler of claim 1, wherein the first servicing track is affixed to an outer top of the safe.

7. The scalable recycler of claim 1, wherein the second servicing track is affixed to an internal wall of the safe.

8. A method for monitoring alignment positioning of components in a scalable recycler of an automated teller machine (ATM) having a safe, the method comprising:
receiving first sensor data from a first hall effect sensor coupled to a first servicing track corresponding to a position of a first moveable component slidably coupled to the first servicing track based on proximity of the first hall effect sensor to a first positioning magnet coupled to the first moveable component, the first servicing track coupled to an intermediate transport component configured to convey media within the ATM;
receiving second sensor data from a second hall effect sensor coupled to a second servicing track corresponding to a position of a second moveable component slidably coupled to the second servicing track based on proximity of the second hall effect sensor to a second positioning magnet coupled to the second moveable component;
determining, using processing circuitry, whether the first moveable component and the second moveable component are aligned within a tolerance threshold based on the first sensor data and the second sensor data; and
outputting an indication of whether the first moveable component and the second moveable component are aligned within the tolerance threshold.

9. The method of claim 8, wherein the tolerance threshold is 2 millimeters along any axis in three dimensions.

10. The method of claim 8, wherein outputting the indication includes outputting the indication during a diagnostic test of the ATM.

11. The method of claim 8, wherein outputting the indication includes outputting a positional error and direction corresponding to the first moveable component or the second moveable component.

12. The method of claim 8, wherein outputting the indication includes outputting the indication on a user interface of the ATM.

13. The method of claim 8, wherein outputting the indication includes outputting a suggested fix to a misalignment of the first moveable component or the second moveable component.

14. The method of claim 13, outputting the suggested fix includes outputting a suggested change to a latch corresponding to the second moveable component.

15. The method of claim 13, outputting the suggested fix includes outputting an indication that the intermediate transport component is compromised.

16. The method of claim 8, wherein the processing circuitry is remote from the ATM.

17. The method of claim 8, wherein the processing circuitry is within the ATM.

18. A scalable recycler of an automated teller machine (ATM), the scalable recycler comprising:
a moveable component including a positioning magnet, the moveable component slidably coupled to a servicing track;
an intermediate transport component affixed to the servicing track, the intermediate transport component configured to convey media within the ATM; and
a hall effect sensor coupled to the servicing track, the hall effect sensor configured to output sensor data corresponding to a position of the moveable component based on proximity of the hall effect sensor to the positioning magnet.

19. The scalable recycler of claim 18, wherein the sensor data includes three-dimensional sensor data.

20. The scalable recycler of claim 18, wherein the servicing track is affixed to an outer top of a safe.
